(19) United States
(12) Patent Application Publication
(10) Pub. No.: US 2007/0013239 A1
(43) Pub. Date: Jan. 18, 2007

(54) Spindle motor

(75) Inventor: Jae Hyun Park, Gyeongsangnam-do (KR)

Correspondence Address: BIRCH STEWART KOLASCH & BIRCH, PO BOX 747, FALLS CHURCH, VA, 22040-0747, US

(73) Assignee: LG INNOTEK CO., LTD

(21) Appl. No.: 11/485,306

(22) Filed: Jul. 13, 2006

(30) Foreign Application Priority Data
Jul. 16, 2005 (JP) 10-2005-0064539

(51) Int. Cl. H02K 5/24; H02K 7/00; H02K 21/12

(52) U.S. Cl. 310/51; 310/156.21; 310/156.26; 310/67 R

(57) ABSTRACT

Provided is a spindle motor. The spindle motor includes a rotor and a stator. The rotor includes a yoke and a flange formed to protrude from an outer perimeter of the yoke. The stator interacts with the rotor to rotate the rotor.

### BACKGROUND OF THE INVENTION

1. Field of the Invention

The present invention relates to a spindle motor.

2. Description of the Related Art

A spindle motor spins a disc so that data stored on the disc can be read by an optical pick-up head performing a straight-line motion. A rotor is coupled to a rotating shaft of the spindle motor.

The rotor includes a yoke coupled to the rotating shaft and a magnet bonded to the inner surface of the yoke. In this configuration, the rotor electromagnetically interacts with the coil windings of a stator so that the rotor rotates. When the rotating shaft rotates, a disc mounted on a turntable connected to the rotating shaft also rotates.

When a spindle motor according to the related art spins at high speed, noise is generated in the natural frequency range of the yoke.

One example of a spindle motor according to the related art uses a 0.8 mm-thick metal yoke with a 23.9 mm outer diameter φ. When this rotor spins at speeds over 4,000 rpm, analysis results using the Fast Fourier Transform (FFT) method show that it generates extraordinarily greater noise at the yoke's natural frequency range of 12 -20 kHz.

This phenomenon can be seen in the graphs in FIGS. 1 and 2.

FIG. 1 is a graph showing results of a first experiment on a spindle motor according to the related art, and

FIG. 2 is a graph showing results of a second experiment on a spindle motor according to the related art.

When the yoke and the a magnet that have been bonded using an adhesive with a 10,000-poise (P=dyn •s/cm²) or more viscosity are rotated, an FFT analysis shows that noise is generated in a 12 -14 kHz range, as shown in FIG. 1.

When the yoke and the a magnet have been bonded using an adhesive with a 10,000-poise (P=dyn •s/cm²) or more viscosity are rotated with gaps therebetween filled with the adhesive, an FFT analysis shows that noise is generated around 14 kHz, as shown in FIG. 2.

The above noise is generated when the spindle motor rotates at a speed above 4,000 rpm, and is an annoyance for a user. Such annoying noise may reduce preference for a spindle motor.

### SUMMARY OF THE INVENTION

Accordingly, the present invention is directed to a spindle motor that substantially obviates one or more problems due to limitations and disadvantages of the related art.

An object of the present invention is to provide a spindle motor with a structure that prevents a noise from being generated within an audio frequency range when its rotor spins at high rpm.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a spindle motor including: a rotor including a yoke and a flange formed to protrude from an outer perimeter of the yoke; and a stator that interacts with the rotor, for rotating the rotor.

In another aspect of the present invention, there is provided a spindle motor including: a rotating shaft; a yoke rotating together with the rotating shaft; a flange formed through outwardly protruding a lower end of the yoke; a magnet disposed on the yoke; coils for interacting with the magnet when power is applied to the coils; and a core around which the coils are wound.

The above-described spindle motor according to the present invention prevents noise occurring within an audio frequency range when a rotor rotates at high speed, thereby minimizing the operational noise level of the spindle motor. Thus, the minimization of noise generation increases consumer preference for the spindle motor.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a graph showing results of a first experiment on a spindle motor according to the related art;

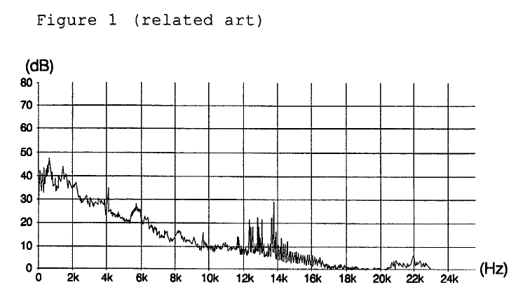

FIG. 2 is a graph showing results of a second experiment on a spindle motor according to the related art;

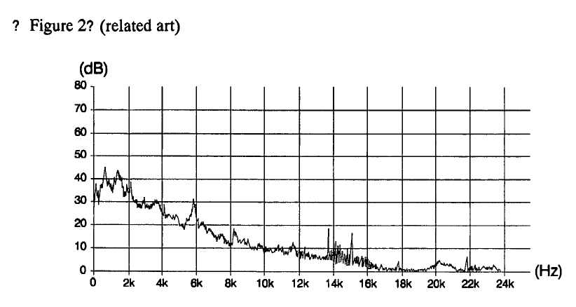

FIG. 3 is a sectional view of a spindle motor according to an embodiment of present invention;

FIG. 4 is an upright sectional view of a spindle motor rotor according to an embodiment of the present invention;

FIG. 5 is a graph showing results of a first experiment on a spindle motor according to an embodiment of the present invention; and

FIG. 6 is a graph showing results of a second experiment on a spindle motor according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

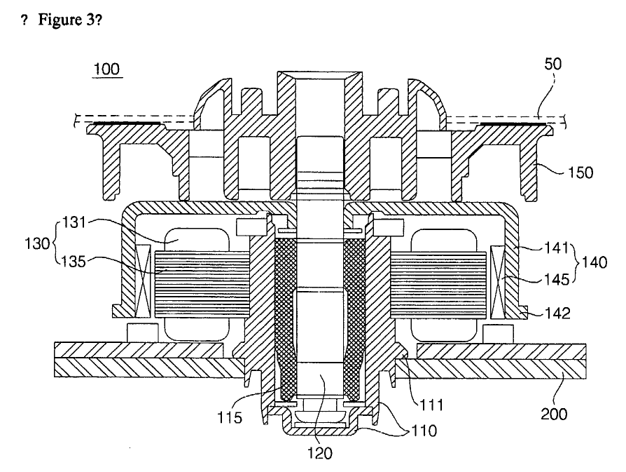

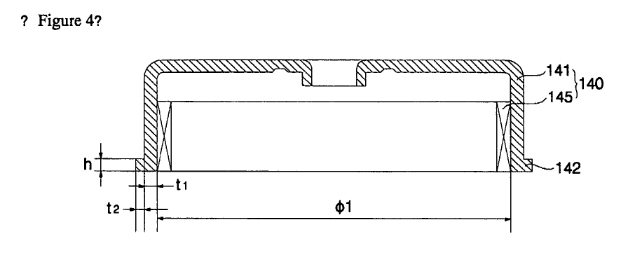

FIG. 3 is a sectional view of a spindle motor according to an embodiment of present invention, and FIG. 4 is an upright sectional view of a spindle motor rotor according to an embodiment of the present invention.

Referring to FIGS. 3 and 4, the spindle motor 100 includes a cylindrical bearing housing 110 open at its top portion and installed to rise from a plate 200. The bearing housing 110 has a caulking portion 111 formed at the perimeter on the bottom end thereof for fixing the bearing housing 110 to the plate 200, and also includes a bearing 115 press-fitted therein.

The lower portion of the rotating shaft 120 is supported by the bearing 115, and the upper portion of the rotating shaft 120 protrudes upward from the bearing housing 110.

A stator 130 having a core 135 and coils 131 wound around the core 135 is fixed to the outer perimeter of the bearing housing 110, and a rotor 140 is coupled to a middle portion of the rotating shaft 120 exposed from the top of the bearing housing 110.

The rotor 140 includes a cylindrical metal yoke 141 that is open at the bottom, fixedly coupled to the rotating shaft 120, and enclosing the stator 130; and a magnet 145 bonded to the inner surface of the yoke 141 and facing the core 135 of the stator 130. Thus, the magnet 145 and the stator 130 electromagnetically interact with each other to rotate the rotor 140 and thus the rotating shaft 120.

A turntable 150 is press-fitted on top of the rotating shaft 120 so that a disc placed thereon rotates in unison with the rotating shaft 120.

Results of a natural frequency harmonic analysis of the rotor 140 clearly show that the noise emitted when the rotor rotates at speeds at 4,000 or more rpm is caused by deformation of the lower end of the metal yoke 141. Due to these analysis results, a flange 142 (with a square sectional shape shown in FIGS. 3 and 4) is formed on the lower outer circumference of the yoke 141 according to an embodiment of the present invention.

The flange 142 protrudes outward from the perimeter at the lower end of the yoke 141. The sectional shape of the flange 142 may adopt a square shape. The flange 142 is formed around the outer perimeter of the yoke 141.

For the sake of manufacturing convenience, the flange 142 may be formed integrally with the yoke 141.

Also, the flange 142 may be formed by bending a portion of the yoke 141. In this embodiment, the flange 142 may be formed by bending the lower end portion of the yoke 141 to protrude in an outward direction from the yoke 141. The flange 142 may be formed on a surface of the yoke 141 opposite to the magnet 145.

Here, the flange 142 formed by bending the lower portion of the yoke 141 may be perpendicular to the yoke 141 when viewed cross-sectionally.

Because the flange 142 is formed on the yoke 141, when the rotor 140 spins at high speeds of 4,000 rpm or more, the noise emitted lies in a frequency range of over 20 kHz, which is inaudible to humans, so that the level of noise emitted within an audio frequency range is reduced.

Here, the thickness tl and the inner diameter φ1 of the yoke 141 are 0.9 - 1.2 mm and 20.8 - 21.0 mm, respectively, and the thickness t2 and the height (h) of the flange 142 are 0.7 - 1.2 mm and 0.9 - 1.2 mm, respectively.

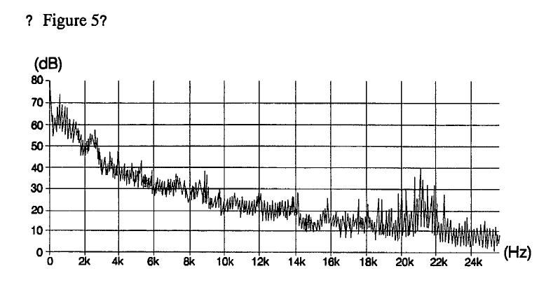

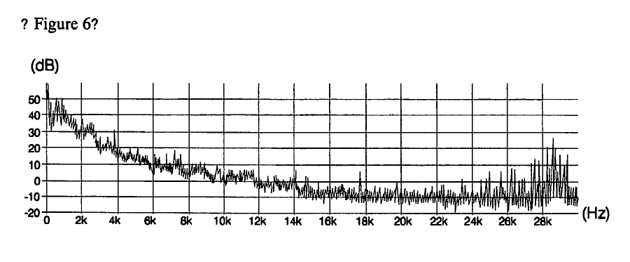

After the thickness t1 and the inner diameter φ1 of the yoke 141 are respectively formed at 1.0 mm and 20.9 mm, and the thickness t2 and height (h) of the flange 142 are respectively formed at 0.75 mm and 1.0 mm, an FFT analysis is performed while the rotor is rotated at a speed of 4,000 or more rpm, as shown in FIGS. 5 and 6.

FIG. 5 is a graph showing results of a first experiment on a spindle motor according to an embodiment of the present invention, and FIG. 6 is a graph showing results of a second experiment on a spindle motor according to an embodiment of the present invention.

When the yoke 141 and the magnet 145 that have been bonded using an adhesive with a 10,000-poise (P =dyn •s/cm²) or more viscosity are rotated, an FFT analysis shows that a noise occurs in a 20 - 22 kHz range, as shown in FIG. 5.

After the yoke 141 and the a magnet 145 have been bonded using an adhesive with a 10,000-poise or more viscosity, and gaps therebetween are filled with an adhesive having 10 - 500 poise, when the yoke 141 and a magnet 145 are rotated, an FFT analysis shows that a noise occurs at 25 kHz or above, as shown in FIG. 6.

That is, it can be seen that the flange 142 formed on the yoke 141 of the rotor 140 according to the embodiment of the present invention alters the frequency range at which noise is emitted to a frequency range above human hearing (i.e., 20 kHz or higher), when the rotor 140 is rotated at high speed.

It is notable that noise occurrence at a higher frequency of 25 kHz or beyond can be obtained by using a high-viscosity adhesive to bond the yoke 141 and the magnet 145, and then using a comparatively low-viscosity adhesive to fill in gaps between the yoke 141 and the magnet 145.

The above-described spindle motor according to the present invention prevents noise occurring within an audio frequency range when a rotor rotates at high speed, thereby minimizing the operational noise level of the spindle motor.

Thus, the minimization of noise generation increases consumer preference for the spindle motor.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A spindle motor comprising:
a rotor including a yoke and a flange formed to protrude from an outer perimeter of the yoke; and
a stator that interacts with the rotor, for rotating the rotor.

2. The spindle motor according to claim 1, wherein the flange is formed at a lower end of the yoke.

3. The spindle motor according to claim 1, wherein the flange is formed by bending a lower end of the yoke.

4. The spindle motor according to the claim 1, wherein the flange is integrally formed with the yoke.

5. The spindle motor according to claim 1, wherein the flange has a substantially rectangular cross-sectional shape.

6. A spindle motor comprising:
a rotating shaft;
a yoke rotating together with the rotating shaft;
a flange formed such that a lower end of the yoke protrudes outwardly;
a magnet disposed on the yoke;
coils for interacting with the magnet when power is applied to the coils; and
a core around which the coils are wound.

7. The spindle motor according to claim 6, wherein the yoke has a thickness in a range of 0.9 to 1.2 mm.

8. The spindle motor according to claim 6, wherein the yoke has an inner diameter in a range of 20.8 to 21.0 mm.

9. The spindle motor according to claim 6, wherein the flange has a thickness in a range of 0.7 to 1.2 mm.

10. The spindle motor according to claim 6, wherein the flange has a height in a range of 0.9 to 1.2 mm.

11. The spindle motor according to claim 6, wherein the yoke and the magnet are bonded using an adhesive with a viscosity of 10,000 poise (P =dyn •s/cm²) or higher.

12. The spindle motor according to claim 6, wherein the yoke and the magnet form a gap therebetween, the gap being filled with an adhesive with a viscosity in a range of 10 to 500 poise.

13. The spindle motor according to claim 6, wherein the flange is substantially perpendicular to a body of the yoke.
